(19) United States
(12) Patent Application Publication
(10) Pub. No.: US 2025/0157254 A1
(43) Pub. Date: May 15, 2025

(54) FACE AUTHENTICATION DEVICE, FACE AUTHENTICATION METHOD, AND INFORMATION STORAGE MEDIUM

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(73) Assignee: Japan Display Inc., Tokyo (JP)

(21) Appl. No.: 18/937,074

(22) Filed: Nov. 5, 2024

(30) Foreign Application Priority Data
Nov. 9, 2023 (JP) 2023-191700

(51) Int. Cl. G06V 40/16; G06F 21/32; G06T 5/73; G06T 7/50

(52) U.S. Cl. CPC G06V 40/172; G06F 21/32; G06T 5/73; G06T 7/50; G06V 40/168

(57) ABSTRACT

A face authentication device includes a monocular camera that includes a coded aperture and captures a face of a user through the coded aperture to acquire a captured image of the face of the user, a depth estimation unit that estimates a depth in at least a part of the captured image by an operation corresponding to the coded aperture, a depth feature information generating unit that generates depth feature information indicating a feature of the face of the user in a depth direction based on the depth, and a depth face authentication unit that authenticates the user based on the depth feature information.

### CROSS-REFERENCE TO RELATED APPLICATION

The present application claims priority from Japanese patent application No. 2023-191700 filed on Nov. 9, 2023, the contents of which are hereby incorporated by reference into this application.

### BACKGROUND

### 1. Field

The present invention relates to a face authentication device, a face authentication method, and an information storage medium.

### 2. Description of the Related Art

Recently, a technique has been known that two-dimensional face authentication using two-dimensional information acquired by a monocular camera is further enhanced in reliability of authentication by using information in a depth direction. For example, Patent literature 1 describes the face authentication technique using depth direction information acquired by a stereoscopic image system. For example, Patent literature 2 describes the face authentication technique using depth direction information acquired by a distance measuring method using an infrared-ray laser.

### CITATION LIST

### Patent Literature

Patent Literature 1: JP2008-123216A
Patent Literature 2: JP2013-250856A

### Non-Patent Literature

Non-Patent Literature 1: A. Levin, et al, “Image and depth from a conventional camera with a coded aperture”, ACM Transactions on Graphics, Vol. 26, No. 3, Article 70, 2007 However, the techniques of Patent literature 1 and Patent literature 2 require additional devices such as a stereo camera, an infrared-laser irradiation device, and a light-receiving device, for face authentication using depth direction information, which is a space-consuming factor.

### SUMMARY

One or more embodiments of the present invention have been conceived in view of the above, and an object thereof is to provide a face authentication device, a face authentication method, and a program for facilitating miniaturization of the device for face authentication using information in a depth direction.

In order to solve the above described problems, a face authentication device according to an aspect of the present invention includes a monocular camera that includes a coded aperture and captures a face of a user through the coded aperture to acquire a captured image of the face of the user, a depth estimation unit that estimates a depth in at least a part of the captured image by an operation corresponding to the coded aperture, a depth feature information generating unit that generates depth feature information indicating a feature of the face of the user in a depth direction based on the depth, and a depth face authentication unit that authenticates the user based on the depth feature information.

A face authentication method according to an aspect of the present invention causes a computer to execute capturing a face of a user by a monocular camera having a coded aperture through the coded aperture to acquire a captured image of the face of the user, estimating a depth in at least a part of the captured image by an operation corresponding to the coded aperture, generating depth feature information indicating a feature of the face of the user in a depth direction based on the depth, and authenticating the user based on the depth feature information.

A non-transitory computer-readable information storage medium according to an aspect of the present invention stores a program that causes a computer to execute capturing a face of a user by a monocular camera having a coded aperture through the coded aperture to acquire a captured image of the face of the user, estimating a depth in at least a part of the captured image by an operation corresponding to the coded aperture, generating depth feature information indicating a feature of the face of the user in a depth direction based on the depth, and authenticating the user based on the depth feature information.

According to an aspect of the present invention, the face authentication device further includes a part area recognition unit recognizes a part area in which a predetermined part of the face of the user is represented based on the captured image, and the depth estimation unit estimates a depth in the part area.

According to an aspect of the present invention, the part area recognition unit recognizes a plurality of part areas respectively representing a plurality of predetermined parts of the face of the user based on the captured image, the depth estimation unit estimates respective depths in the plurality of part areas, and the depth feature information generating unit generates, as the depth feature information, relative depths of a plurality of parts with respect to a predetermined part among the plurality of parts based on the respective depths in the plurality of part areas.

According to an aspect of the present invention, the face authentication device further includes a two-dimensional face authentication unit that performs two-dimensional face authentication based on the captured image.

According to an aspect of the present invention, the face authentication device further includes a blur removing unit that removes a blur from the captured image by the operation corresponding to the coded aperture to generate a blur-removed image, wherein the part area recognition unit recognizes the part area based on the blur-removed image.

According to an aspect of the present invention, the two-dimensional face authentication unit performs the two-dimensional face authentication based on the blur-removed image.

According to an aspect of the present invention, the depth feature information generating unit calculates an average value of the depths in the respective part areas for each of the plurality of parts and generates the depth feature information based on the average value.

### BRIEF DESCRIPTION OF THE DRAWINGS

FIG. 1 is a diagram illustrating an overall configuration of a face authentication device;

FIG. 2 is a diagram illustrating an example of data processing related to face authentication;

FIG. 3 is a diagram showing an example of processing of generating depth feature information;

FIG. 4 is a flow chart showing an example of processing of depth face authentication;

FIG. 5 is a diagram illustrating an example of a hardware configuration for implementing the face authentication device; and

FIG. 6 is a block diagram showing an example of functions implemented by the face authentication device.

### DETAILED DESCRIPTION

Embodiments of the present invention will be described below in detail with reference to the accompanying drawings.

### 1. Overall Configuration of Face Authentication Device

The face authentication device according to the present embodiment uses depth direction information acquired by estimating depths using a coded-aperture imaging technique.

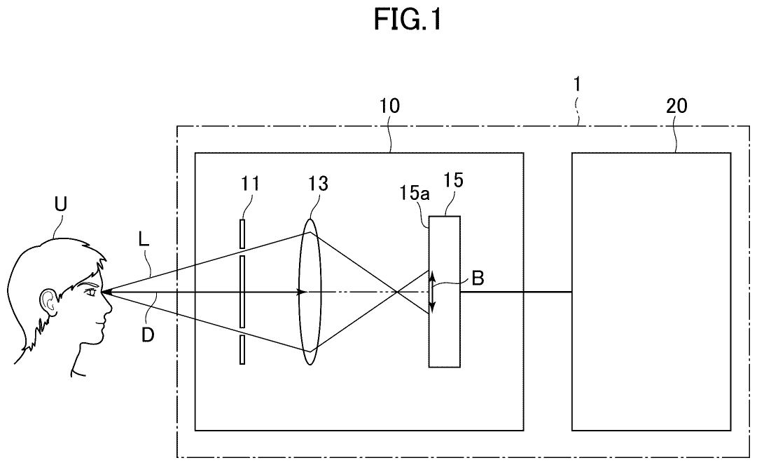

FIG. 1 is a diagram illustrating an overall configuration of a face authentication device. As shown in FIG. 1, a face authentication device 1 includes a monocular camera 10 and a control device 20. The monocular camera 10 includes a coded aperture 11, a lens 13, and an imaging device 15.

The coded aperture 11 has an aperture area and a light-shielding area in a geometric pattern, allowing a part of light L incident on the lens 13 to pass therethrough and shielding the other part of the light L. The lens 13 collects the light L coming from a subject to form an image on a light receiving surface 15a of the imaging device 15. The imaging device 15 is an electronic component that performs photoelectric conversion. The imaging device 15 photoelectrically converts the brightness of the image formed on the light receiving surface 15a into an amount of electric charges, captures the photoelectrically converted electric signal, and acquires a captured image.

The monocular camera 10 captures the face of a user U through the coded aperture 11, thereby acquiring a captured image indicating the face of the user U. The image is captured by focusing on a part of the face. At this time, blurring due to defocus occurs where the part that is not focused in the captured image. For example, when focusing on the eye of the user U to capture an image, blurring does not occur at the position of the eye that is focused, but occurs at the position of the nose. A size B of the blur varies depending on a depth D, which is the distance from the subject to the lens 13.

The control device 20 is connected to the imaging device 15. The control device 20 performs various kinds of processing on the captured image obtained from the imaging device 15. The control device 20 is a computer, for example.

### 2. Details of Embodiment

In the present embodiment, the two-dimensional face authentication and the depth face authentication, which is face authentication in the depth direction, are performed on one captured image.

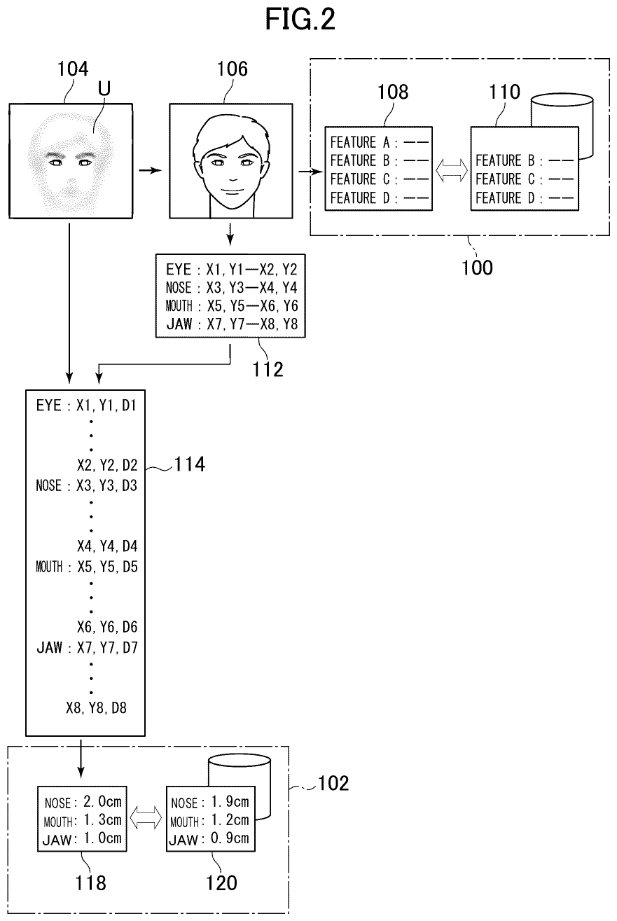

FIG. 2 is a diagram illustrating an example of the data processing related to the face authentication. The blur removal processing is executed on the captured image 104, which is acquired by the monocular camera 10 having the coded aperture 11 and indicates the face of the user U to be authenticated, by the operation corresponding to the coded aperture 11, whereby a blur-removed image 106 is generated. Subsequently, two-dimensional feature information 108 indicating features of the face of the user U on the two-dimensional image is generated based on the blur-removed image 106. The two-dimensional feature information 108 is collated with the two-dimensional user information 110, which is registered in advance as registration data used for the two-dimensional face authentication 100, and the two-dimensional face authentication 100 is thereby performed. Further, the area in which the part of the face of the user U is represented is also recognized based on the blur-removed image 106, and part area recognition information 112 is generated. The depth D is estimated by the operation corresponding to the coded aperture 11 based on the captured image 104 and the part area recognition information 112, and the depth estimation information 114 is thereby generated. Subsequently, depth feature information 118 indicating the feature of the face of the user U in the depth direction is generated based on the depth estimation information 114. The depth feature information 118 is then collated with the depth user information 120 registered in advance as the registration data used for the depth face authentication 102, whereby the depth face authentication 102 is performed to authenticate the user U.

As described above, the present embodiment enables to estimate the depth D from the captured image 104 acquired by the monocular camera 10 having the coded aperture 11. This eliminates the need to additionally introduce devices, such as a stereo camera, an infrared-ray laser irradiation device, and a light receiving device, and facilitates miniaturization of a device for face authentication using the information in the depth direction.

Further, the present embodiment enables to perform both the two-dimensional face authentication 100 and the depth face authentication 102 from one captured image 104, and this facilitates reducing the time required to acquire the data for authenticating the user U.

The processing for the depth face authentication 102 may be performed only when the authentication is performed by the two-dimensional face authentication 100. For example, in a case where the two-dimensional face authentication 100 is performed first and the user is authenticated, the processing proceeds to the processing for the depth face authentication 102, such as recognizing the part area to generate the part area recognition information 112 and then estimating the depth to generate the depth estimation information 114. In a case where the user is not authenticated by the two-dimensional face authentication 100, the processing does not proceed to processing for the depth face authentication 102, and the authentication fails and such a result is output.

As described above, according to the present embodiment, the processing for the depth face authentication 102 is performed only when the user is authenticated by the two-dimensional face authentication 100. This facilitates reducing the processing load of the computer.

The captured image 104 indicates the face of the user U to be authenticated. The captured image 104 is acquired when the monocular camera 10 having the coded aperture 11 captures the face of the user U through the coded aperture 11. The captured image 104 includes a plurality of pixels.

The blur-removed image 106 is generated by removing blurs on the captured image 104 by the operation corresponding to the coded aperture 11. The operation corresponding to the coded aperture 11 is performed using a well-known technique used in the coded-aperture imaging technique. For example, the technique described in Non-Patent Literature 1 may be used. The blur-removed image 106 may not necessarily be a completely blur-removed image, but may be a blur-reduced image.

The two-dimensional feature information 108 indicates a feature of the face of the user U on the two-dimensional image and is used as collation data for performing the two-dimensional face authentication 100. The two-dimensional feature information 108 is generated based on the blur-removed image 106, for example. For example, the pixel coordinates representing positions of parts of the face of the user U in images, such as eyes, nose, mouth, jaw, eyebrows, and cheeks, are recognized in the blur-removed image 106, and the two-dimensional feature information 108 is generated based on such pixel coordinates. The format of the two-dimensional feature information 108 shown in FIG. 2 is merely an example, and other formats commonly used in the two-dimensional face authentication technique may be used.

The two-dimensional user information 110 indicates characteristics of the face of the user U on the two-dimensional image and is registered in advance as the registration data to be used for the two-dimensional face authentication 100. The two-dimensional user information 110 is data having the same format as the two-dimensional feature information 108.

The two-dimensional face authentication 100 is performed using a known technique as the authentication method not using the depth information of images. For example, the two-dimensional face authentication 100 may be performed using machine learning. In the present embodiment, the two-dimensional face authentication 100 is performed based on the captured image 104. More specifically, the two-dimensional face authentication 100 may be performed based on the blur-removed image 106 generated by removing the blur from the captured image 104. For example, the two-dimensional feature information 108 may be generated based on the blur-removed image 106 and collated with the two-dimensional user information 110, whereby the two-dimensional face authentication 100 may be performed.

As described above, in the present embodiment, the two-dimensional face authentication 100 is performed based on the blur-removed image 106 generated by removing the blur from the captured image 104, thereby easily improving the accuracy of the authentication.

The part area recognition information 112 indicates a result in which a part area representing a predetermined part of the face of the user U is recognized based on the captured image 104. There may be a plurality of predetermined parts of the face of the user U. For example, in a case where a plurality of parts of the face, such as eyes, nose, mouth, and jaw, are determined in advance, the part area recognition information may be the information indicating the result of the recognition of the areas respectively representing the eyes, nose, mouth, and jaw. For example, the area is a rectangle surrounding the part of the face. In the part area recognition information 112 shown in FIG. 2, for example, X1, Y1 to X2, and Y2 of the area representing the eyes indicate the pixel coordinates of diagonally opposite corners of the rectangle area. The format of the part area recognition information 112 shown in FIG. 2 is an example, and other formats commonly used in the image recognition technique may also be used. The part area may be recognized using techniques well known in the field of image recognition. For example, the part area may be recognized using machine learning. The part area recognition information 112 may indicate a result of recognition of the part area based on the blur-removed image 106 generated by removing the blur from the captured image 104. In this case, the part area is recognized by performing a predetermined operation on the blur-removed image 106 using a trained model, for example.

As described above, according to the present embodiment, the part area is recognized based on the blur-removed image 106 generated by removing the blur from the captured image 104, and this facilitates improving the accuracy of the recognition.

The depth estimation information 114 indicates the result of estimating a depth D in at least a part of the captured image 104 by the operation corresponding to the coded aperture 11. More specifically, the depth estimation information 114 may indicate a result of estimating the depth D in the part area recognized in the previous step of the part area recognition processing. In a case where a plurality of part areas are recognized in the previous step of the part area recognition processing, the depths D in respective part areas are estimated. The operation corresponding to the coded aperture 11 is performed using a well-known technique used in the coded-aperture imaging technique. For example, the technique described in Non-Patent Literature 1 may be used. The format of the depth estimation information 114 is as illustrated in FIG. 2, for example. In the depth estimation information 114 shown in FIG. 2, X1, Y1, and D1 of the area representing the eyes indicate that the estimation result of the depth D in the pixels of the pixel coordinates X1, Y1 is D1. The format of the depth estimation information 114 illustrated in FIG. 2 is an example and is not limited to this. The operation corresponding to the coded aperture 11 may be performed at predetermined intervals, such as every 20 pixels in the vertical direction and every 20 pixels in the horizontal direction. The operation corresponding to the coded aperture 11 may be performed not on the entire captured image 104 but only on the portions corresponding to the part areas recognized in the previous step of the part area recognition processing.

As described above, according to the present embodiment, the depth estimation processing is executed only on the recognized part area, and this serves to reduce the processing load of the computer.

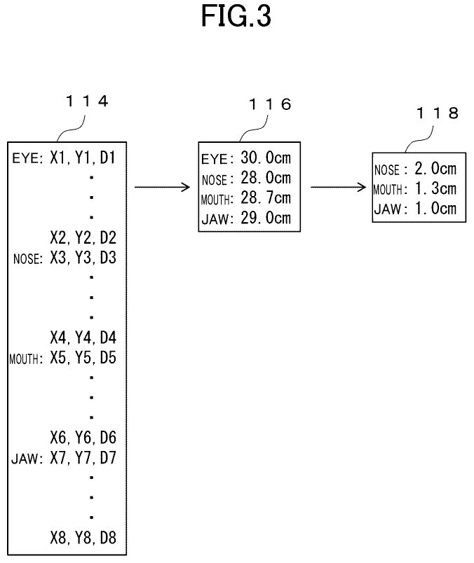

The depth feature information 118 can be used as collation data for performing the depth face authentication 102. The depth feature information 118 indicates a feature of the face of the user U in the depth direction generated based on the depth D estimated by the depth estimation in the previous step. More specifically, the depth feature information 118 may be information on relative depths of a plurality of parts with respect to a predetermined part among the plurality of parts. The relative depths are calculated based on the depths D in the respective part areas estimated by the depth estimation in the previous step. Further, the depth feature information 118 may be generated based on an average value of the depths D in the respective part areas for each of the parts, where the depths D are estimated by the depth estimation processing in the previous step. As shown in FIG. 3, the average value of the depths D is calculated for each of the eyes, nose, mouth, and jaw from the depth estimation information 114 indicating the depths D in the respective areas showing the eyes, nose, mouth, and jaw to thereby generate the depth average information 116. For example, using the eyes (30.0 cm) as a reference, the differences between the eyes and the parts other than the eyes, such as the nose (28.0 cm), the mouth (28.7 cm), and the jaw (29.0 cm), are calculated as relative depths. In this manner, the relative depths of the respective parts, such as the nose (2.0 cm), the mouth (1.3 cm), and the jaw (1.0 cm), relative to the eyes are generated as the depth feature information 118.

As described above, according to the present embodiment, the depth feature information 118 based on the averages of the depths D for each part is generated, and this serves to reduce the influence of errors and facilitate improving the reliability of the face authentication.

The depth user information 120 indicates the feature of the face of the user U in the depth direction and is registered in advance as registration data to be used for the depth face authentication 102. The depth user information 120 is data having the same format as the depth feature information 118.

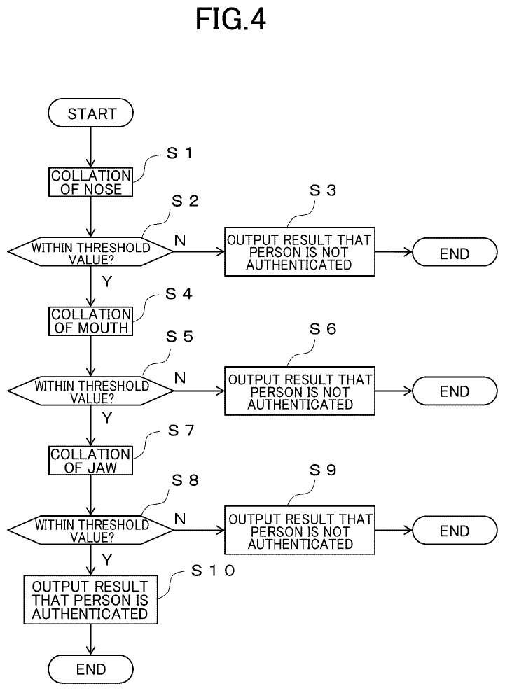

The depth face authentication 102 is to authenticate the user U based on the depth feature information 118. For example, the depth face authentication 102 is performed by collating the depth feature information 118 with the depth user information 120 registered in the user device in advance. As shown in FIG. 4, the depth face authentication 102 may sequentially perform collation and determination of each part. For example, the collation of the nose is performed first (S1) to determine whether the difference between the value of the nose in the depth feature information 118 and the value of the nose in the depth user information 120 is within a threshold value (S2). If it is not determined that the difference is within the threshold value in S2, the determination result that the person is not the user U is output (S3). If it is determined that the difference is within the threshold value in S2, the processing proceeds to the collation of the mouth (S4). Similarly, it is determined whether the difference between the value of the mouth in the depth feature information 118 and the value of the mouth in the depth user information 120 is within the threshold value (S5). If it is not determined that the difference is within the threshold value in S5, the determination result that the person is not the user U is output (S6). If it is determined that the difference is within the threshold value in S5, the processing proceeds to the collation of the jaw (S7). Similarly, it is determined whether the difference between the value of the jaw in the depth feature information 118 and the value of the jaw in the depth user information 120 is within the threshold value (S8). If it is not determined that the difference is within the threshold value in S8, the determination result that the person is not the user U is output (S9). If it is determined that the difference is within the threshold value in S8, the determination result that the person is the user U is output (S10).

As described above, according to the present embodiment, the respective parts are sequentially determined, and this facilitates reducing the processing load of the computer.

### 3. Hardware Configuration for Face Authentication Device

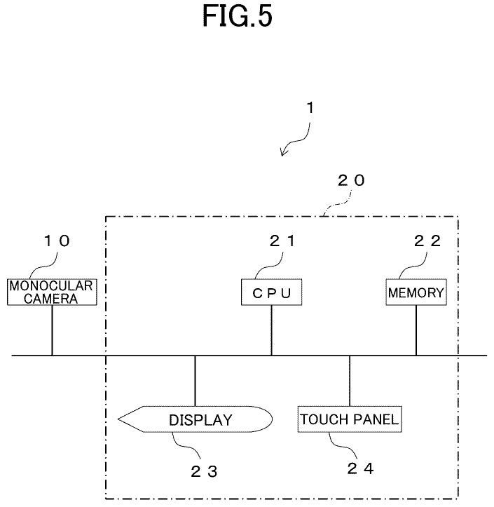

Referring to FIG. 5, a hardware configuration for implementing the face authentication device 1 according to the present embodiment will be described. In the present embodiment, the face authentication device 1 is mounted on a device, such as a smart phone.

FIG. 5 is a diagram illustrating an example of a hardware configuration for implementing the face authentication device 1. As shown in FIG. 5, the control device 20 includes a CPU 21, a memory 22, a display 23, and a touch panel 24.

The CPU 21 includes at least one processor. The CPU 21 is a type of circuitry. The memory 22 includes a random access memory (RAM) and a storage such as a universal flash storage (UFS), and stores programs and data. The CPU 21 executes various types of processing based on these programs and data. The display 23 is a liquid crystal display and an organic EL display, for example, and displays an operating screen according to an instruction of the CPU 21. The touch panel 24 is provided on the display surface of the display 23, and detects a touch operation on the surface of the touch panel 24 using a touch sensor, such as a capacitive touch sensor and a resistive film touch sensor.

The programs and data described as being stored in the memory 22 may be supplied to the control device 20 via a network. The hardware configuration of the control device 20 is not limited to the example described above, and various types of hardware can be applied. For example, the control device 20 may include a reading unit (e.g., optical disk drive, memory card slot) for reading a computer-readable information storage medium and an input/output unit (e.g., USB terminal) for directly connecting to an external device. In this case, the program or data stored in the information storage medium may be supplied to the control device 20 via the reading unit or the input/output unit.

### 4. Functions Implemented by Face Authentication Device

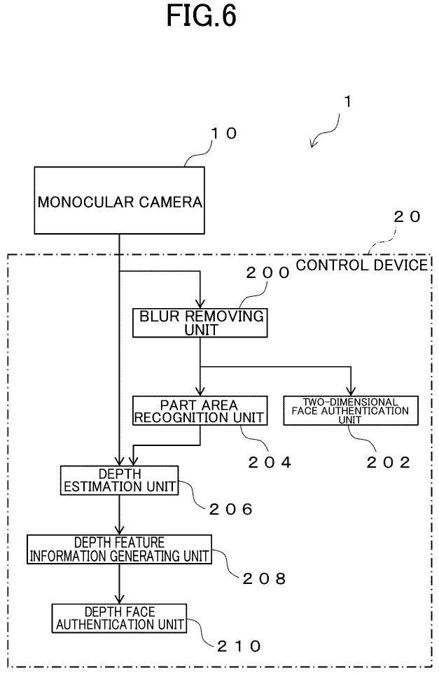

Referring to FIG. 6, a functional configuration of the control device 20 will be described.

FIG. 6 is a block diagram showing an example of functions implemented in the face authentication device 1. As shown in FIG. 6, the control device 20 includes a blur removing unit 200, a two-dimensional face authentication unit 202, a part area recognition unit 204, a depth estimation unit 206, a depth feature information generating unit 208, and a depth face authentication unit 210. These functions operate according to the programs stored in the memory 22.

As described in the example of the data processing related to the face authentication in the present embodiment, the blur removing unit 200 removes the blur from the captured image 104 by the operation corresponding to the coded aperture 11, thereby generating the blur-removed image 106.

The two-dimensional face authentication unit 202 performs two-dimensional face authentication 100 based on the captured image 104. For example, the two-dimensional face authentication unit 202 performs the two-dimensional face authentication 100 based on the blur-removed image 106 generated by removing the blur from the captured image 104.

The part area recognition unit 204 recognizes a part area in which a predetermined part of the face of the user U is represented based on the captured image 104. For example, the part area recognition unit 204 recognizes a plurality of part areas respectively representing a plurality of predetermined parts of the face of the user U based on the captured image 104. For example, the part area recognition unit 204 recognizes the part area based on the blur-removed image 106 generated by removing the blur from the captured image 104.

The depth estimation unit 206 estimates the depth D of at least a part of the captured image 104 by the operation corresponding to the coded aperture 11. For example, the depth estimation unit 206 estimates the depth D in the area recognized by the part area recognition unit 204. For example, the depth estimation unit 206 estimates the depths D in the respective part areas recognized by the part area recognition unit 204.

The depth feature information generating unit 208 generates depth feature information indicating a feature of the face of the user U in the depth direction based on the depth D estimated by the depth estimation unit 206. For example, the depth feature information generating unit 208 generates, as the depth feature information, relative depths of a plurality of parts with respect to a predetermined part among the plurality of parts. The relative depths are calculated based on the depths D in the respective part areas estimated by the depth estimation unit 206. For example, the depth feature information generating unit 208 calculates an average value of the depths D, in the respective part areas estimated by the depth estimation unit 206, for each of the plurality of parts, and generates depth feature information based on the average values.

The depth face authentication unit 210 authenticates the user U based on the depth feature information generated by the depth feature information generating unit 208.

### 5. Modification

The present invention is not limited to the embodiments described above. The present invention may be changed as appropriate without departing from the spirit of the present disclosure.

For example, the part area recognition information 112 generated by the two-dimensional face authentication 100 and recognition of the part area may be generated directly from the captured image 104 instead of from the blur-removed image 106.

As described above, according to the present modification, the part area recognition information 112 generated by the two-dimensional face authentication 100 and the recognition of the part area is directly generated from the captured image 104, and this facilitates reducing the processing load of the computer.

It should be understood by those skilled in the art that various modifications, combinations, sub-combinations and alterations may occur depending on design requirements and other factors insofar as they are within the scope of the appended claims or the equivalents thereof.

What is claimed is:

1. A face authentication device comprising:
a monocular camera that includes a coded aperture and captures a face of a user through the coded aperture to acquire a captured image of the face of the user;
a depth estimation unit that estimates a depth in at least a part of the captured image by an operation corresponding to the coded aperture;
a depth feature information generating unit that generates depth feature information indicating a feature of the face of the user in a depth direction based on the depth; and
a depth face authentication unit that authenticates the user based on the depth feature information.

2. The face authentication device according to claim 1, further comprising a part area recognition unit recognizes a part area in which a predetermined part of the face of the user is represented based on the captured image, wherein
the depth estimation unit estimates a depth in the part area.

3. The face authentication device according to claim 2, wherein
the part area recognition unit recognizes a plurality of part areas respectively representing a plurality of predetermined parts of the face of the user based on the captured image,
the depth estimation unit estimates respective depths in the plurality of part areas, and
the depth feature information generating unit generates, as the depth feature information, relative depths of a plurality of parts with respect to a predetermined part among the plurality of parts based on the respective depths in the plurality of part areas.

4. The face authentication device according to claim 3, further comprising a two-dimensional face authentication unit that performs two-dimensional face authentication based on the captured image.

5. The face authentication device according to claim 4, further comprising a blur removing unit that removes a blur from the captured image by the operation corresponding to the coded aperture to generate a blur-removed image, wherein
the part area recognition unit recognizes the part area based on the blur-removed image.

6. The face authentication device according to claim 5, wherein
the two-dimensional face authentication unit performs the two-dimensional face authentication based on the blur-removed image.

7. The face authentication device according to claim 6, wherein
the depth feature information generating unit calculates an average value of the depths in the respective part areas for each of the plurality of parts and generates the depth feature information based on the average value.

8. A face authentication method, causing a computer to execute:
capturing a face of a user by a monocular camera having a coded aperture through the coded aperture to acquire a captured image of the face of the user;
estimating a depth in at least a part of the captured image by an operation corresponding to the coded aperture;
generating depth feature information indicating a feature of the face of the user in a depth direction based on the depth; and
authenticating the user based on the depth feature information.

9. A non-transitory computer-readable information storage medium storing a program for causing a computer to execute:
capturing a face of a user by a monocular camera having a coded aperture through the coded aperture to acquire a captured image of the face of the user;
estimating a depth in at least a part of the captured image by an operation corresponding to the coded aperture;
generating depth feature information indicating a feature of the face of the user in a depth direction based on the depth; and
authenticating the user based on the depth feature information.
